(19) United States
(12) Patent Application Publication
(10) Pub. No.: US 2008/0170562 A1
(43) Pub. Date: Jul. 17, 2008

(54) Method and communication device for improving the performance of a VoIP call

(75) Inventor: Chien-Fu Sung, Sanchong City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/652,544

(22) Filed: Jan. 12, 2007

(51) Int. Cl. H04L 12/66

(52) U.S. Cl. 370/352

(57) ABSTRACT

A sub-data packet drop method and a dynamic base method for improving the performance of voice calls routed through data packet networks. A voice engine processor of the present invention comprises a smart jitter buffer, which is a jitter buffer couples with a sub-data packet drop method and a dynamic base method to prevent an anomaly that result from data packet scramble or delay. One advantage of the present invention is utilizing dynamic base method to avoid misjudging the delayed time of data packets. This method utilizes timestamp field in RTP header to dynamically change the base packet to compensate for initial jitter delay, and then the total voice latency can be reduced. Another advantage of the present invention is utilizing sub-data packet drop method by which a segment of data packet stream representing background noise or silence would be dropped; consequently the quality of voice call can be smoother.

### TECHNICAL FIELD OF THE PRESENT INVENTION

This invention relates to a method and a device for improving the performance of voice calls routed through data packet networks and, more particularly, relates to a to a sub-data packet drop method and a dynamic base method and a device thereof for improving the performance of voice calls routed through data packet networks.

### BACKGROUND OF THE PRESENT INVENTION

Traditional voice communication, for example telephone, is analog; therefore, to implement real-time audio transmission via data packet networks, for example internet, it is necessary to convert the analog voice signal into digital voice signal. To achieve this goal, the general way for signal transformation is proceeded by encoder and DPU of a communication device; then, the data packet stream formed thereof can transmits to the recipient over data packet networks.

Unlike a telephone network, there doesn't exist a dedicated connection constructed between the source and the destination in internet communication; internet, for example, utilizing TCP or UDP and so on as communication protocol, is a datagram-oriented network; therefore, between the source and destination of an internet communication, there doesn't exist a dedicated connection.

Consequently, data packets may travel through different paths from the source to the destination and may travel at different speed. As a result, as shown in FIG. 2, data packets transmitted over data packet networks may arrive out of order or received in bunches or with unexpected gaps between the bunches at the receiver. Consequently, if the delayed time of data packets is out of tolerance time range, a traditional communication device has to drop a segment of delayed data packets to avoid affecting other data packets arrived in time.

Internet is also a kind of connectionless network, which means that it permits data packet lost when transmitted and would not retrieve them, when that happens, this segment of the data stream can't be reconstructed at its destination. Therefore, if the phenomenon of data packet scramble or data packet lost mentioned above happens too often, then the recipient may hear annoying gaps in the reconstructed speech.

To overcome the problems mentioned above, one of the resolutions is adding a jitter buffer in a communication device. The principle of a jitter buffer is providing a buffer which can store data packets as they are received from the network to perform some actions on stored data packets. Theoretically, a data packet receiver in the destination stores the received data packets in a jitter buffer, and then after some calculations, for example, delayed time calculation, determines which part of data packets should be dropped; next, sorting the remaining data packets, and then forwards the sorted data packets to the listener at the rate at which it was generated in the data packet transmitter in the source. Therefore, by adding a jitter buffer in a communication device, the communication device can tolerate that data packets arrive out of order and prevent an anomaly that could be experienced.

Though adding a jitter buffer in a communication device can increase the tolerance of data packets scramble of internet phone system theoretically, the traditional way in deciding which data packets in the jitter buffer should be dropped is still not precise enough; consequently, the quality of restored speech still suffers unnecessary decreases.

For example, traditionally, the first arriving data packet in the jitter buffer of a data packet stream is deemed as the base packet used for calculating the delayed time of after coming data packets of the data packet stream, but it is not a baseline precise enough for delayed time calculation. As shown in the above paragraph, data packets travel through different paths from the source to the destination; so that it is not reasonable to use first arriving data packet as the base packet in determining the delayed time of after coming data packets of the data packet stream. Referring to the FIG. 3, by traditional way, the result of calculation makes the delayed time of the after coming data packet longer than they really are. For example, referring to FIG. 3 again, the traditional method would take data packet 1 as base packet to calculate the delayed time of after coming data packets of the data packet stream, and then, as shown in FIG, 3 the data packet 2, 3, 5, 7 would be misjudged as the data packets arriving out of tolerable time range. As a result, system would misjudge that the delayed time of the after coming data packets are beyond the tolerable time zone and then drop these data packets; therefore, this imprecise calculation causes unnecessary voice information lost.

Besides imprecise baseline selection for delayed time, traditional processing method is unable to choose which part of delayed data packets to be dropped; consequently, the quality of reconstructed voice may suffer another unnecessary decrease. For example, Real-time audio, transmitted during the telephone conversation includes desired audio (spoken words) and undesired audio (background noise). While words are being spoken, the transmitted audio contains both spoken words and background noise; while words are not being spoken, the transmitted audio contains only background noise. Traditionally, the system would drop the delayed data packet out of tolerable range without selection; therefore, as shown in FIG. 5, the system may drop the delayed data packet stream segments representing spoken words or background noise or both. Consequently, by traditional processing method, the system drop delayed data packets without selection and may cause unnecessary data lost.

Therefore, Regarding to the questions mentioned above, the present invention provides a sub-data packet drop method and a dynamic base method and device thereof for improving the quality of voice calls routed through data packet networks.

### BRIEF SUMMARY OF THE PRESENT INVENTION

This invention provides a sub-data packet drop method and a dynamic base method and device thereof for improving the performance of voice calls routed through data packet networks.

The present invention comprises a call control unit, a voice engine processor, an I/O unit and a network interface; wherein the voice engine processor of the present invention comprises a smart jitter buffer, which is a jitter buffer couples with a sub-data packet drop mechanism or a dynamic base mechanism to prevent an anomaly that result from data packet scramble or lost.

One advantage of the present invention is utilizing a dynamic base method to avoid misjudging the delayed time of data packets; this method utilizes delayed time of an incoming data packet to dynamically change the delayed time of base packet to avoid causing unnecessary data lost.

Another advantage of the present invention is utilizing sub-data packet drop method by which a segment of delayed data packet stream representing background noise or silence rather than a segment represents spoken words would be dropped; consequently the quality of a voice call can be smoother.

### BRIEF DESCRIPTION OF DRAWINGS

FIG. 1 illustrates a communication device made according to an embodiment of the present invention.

FIG. 2 shows voice quality issues caused by network environment.

FIG. 3 shows the difference between a traditional method and the dynamic base method in dealing with data packet scramble problem.

FIG. 4 illustrates a schematic diagram of the dynamic base method according to the present invention.

FIG. 5 shows the difference between a traditional method and the sub-data packet drop method when determining which segment of delayed data packet should be dropped.

FIG. 6 illustrates a schematic diagram of the sub-data packet drop method according to the present invention.

### DETAILED DESCRIPTION OF THE PRESENT INVENTION

The invention will now be described in greater detail with preferred embodiments of the present invention and illustrations attached. Nevertheless, it should be recognized that the preferred embodiments of the present invention is only for illustrating. Besides the preferred embodiment mentioned here, present invention can be practiced in a wide range of other embodiments besides those explicitly described, and the scope of the present invention is expressly not limited expect as specified in the accompanying Claims.

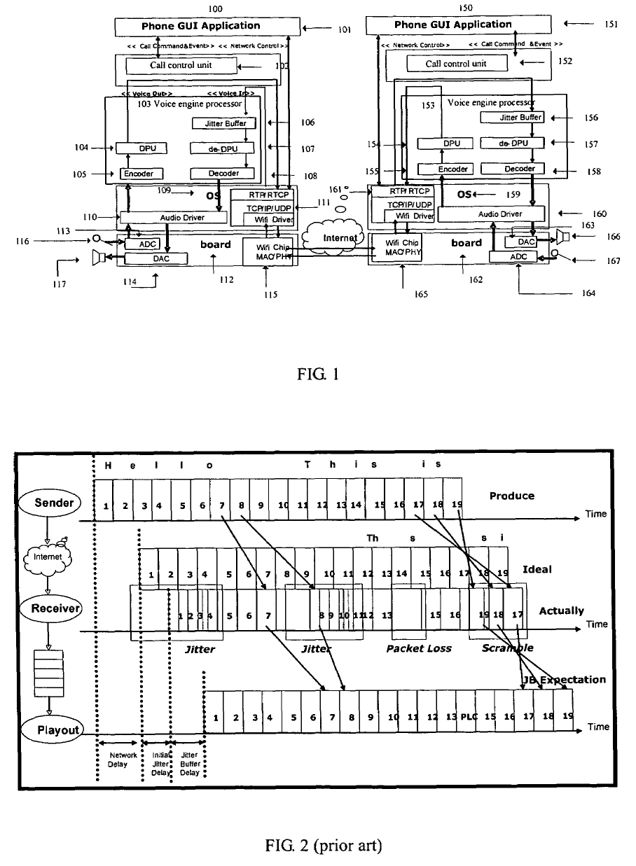

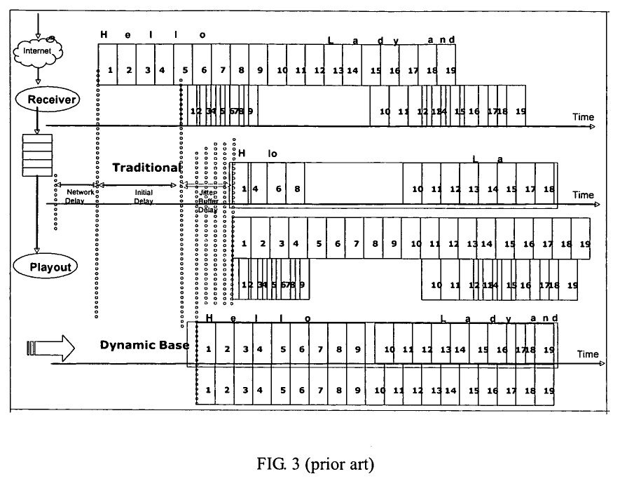

FIG. 1 illustrates two identical communication devices 100 and 150 made according to an embodiment of the present invention. As shown in the FIG. 1, a communication device 100 comprises a phone graph user interface (GUI) application 101 by which users can interact with a communication device 100; a call control unit 102 which processes the call command and event is coupled to the phone GUI application 101 ; a voice engine processor 103 comprising an encoder 105, a decoder 108, a data packeting unit (DPU) 104, a de-data packeting unit (de-DPU) 107, and a jitter buffer 106, is coupled to the call control unit 102 to process the voice signal; an operation system (OS) 109 is coupled to the voice engine processor 103. The operation system (OS) 109 comprises a audio driver 110 and a wifi driver 111 to control the hardware of a communication device 100; and a board 112 comprises a sound card and a network interface 115; wherein the sound card mentioned above comprises an analog to digital converter (ADC) 113, a digital to analog converter (DAC) 114, and a network interface 115 mentioned above comprises a wifi chip.

As shown in FIG. 1, a communication device 100 is controlled by a phone GUI application 101, by which users can execute call control. When a communication device 100 receives an analog voice signal, for example, from microphone 116, the analog voice signal is transmitted to an ADC 113 to convert the analog voice signal to digital voice signal. Next, an encoder 105 compresses the digital voice signal to generate compressed voice data and then the DPU 104 attaches a header and a trailer to the compressed voice data to generate data packets. Next, through the network interface 115, the data packets can be transmitted through data packet networks between the communication devices.

When the destined communication device 150 receives the data packets from the source communication device 100, a jitter buffer 156 stores data packets of a data packet stream, and then several actions are performed on the data packets to determine which part of the delayed data packets should be dropped and sort the sequence of the receiving data packets. After dropping and sorting process, a de-DPU 157 of the communication device 150 detaches the header and the trailer from the remaining data packets stored in the jitter buffer 156 to generate compressed voice data, and then a decoder 158 decompresses the compressed voice data to generate a digital voice signal. At last, a DAC 163 converts the digital voice signal to the analog voice signal and then to play the reconstruct voice by a speaker 166.

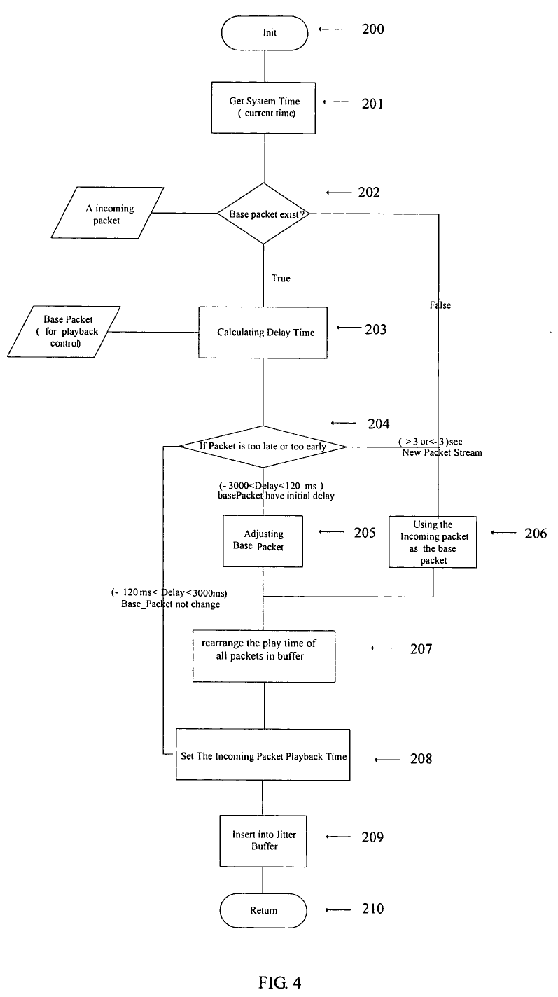

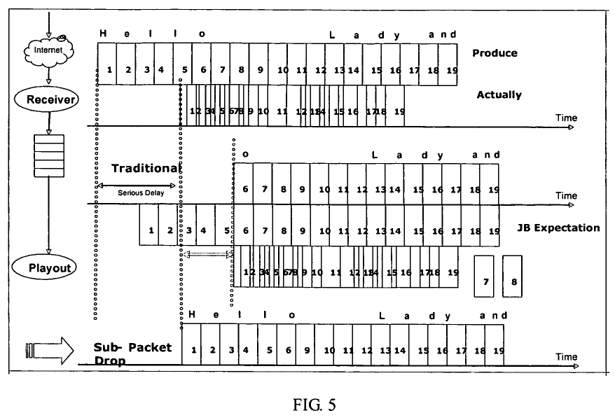

FIG. 3 and FIG. 4 illustrate schematic diagrams of an embodiment of the dynamic base method for improving the quality of a reconstructed voice call. Referring to FIG. 4, in step 201, the system gets system time (Ts) for calculating arriving time of an incoming data packet. In the following step 202, a communication device receives an incoming data packet from data packet networks, and then determines whether a base packet exists in a jitter buffer or not; if the determination is positive, then the next step flows to step 203 to calculate the delayed time of the incoming data packet; if it is negative, step flows to step 206 and takes this incoming data packet as a new base packet and calculates a play time for the new base packet. In one embodiment of the present invention, if the arriving time of the incoming data packet is earlier or later than 3 seconds than expected time, the incoming data packet is regard as a new base packet. In another embodiment of the present invention, the expected time refers to the time recorded by time stamp of the incoming data packet plus network delay. In another embodiment of the present invention, the play time of the base packet mentioned above can be calculated as follows:

Tbp=Ts+Tbf
Tbp: play time of the base packet
Ts: arriving time of the base packet
Tbf: buffer delay of the base packet

Then, step flows to step 207 to adjust the play time of all data packets in the jitter buffer. In one embodiment of the present invention, the play time of the data packets in a jitter buffer can be adjusted as below:

Tpbuf(new)=Tpbuf(old)−Tlp−Tld+Tbp
Tpbuf (new): new play time of the data packets stored in a jitter buffer
Tpbuf (old): old play time of the data packets stored in a jitter buffer
Wherein Tbm can be defined as below:

Tbm=Tlp+Tld−Tbp
Tlp: play time of the last data packet
Tld: duration time of the last data packet
Tbp: play time of the base packet

Subsequently, step flows to step 208 in which setting a play time to the new base packet. In one embodiment of the present invention, the play time of the incoming data packet can be calculated as follows:

Tpi=Tbp+(Tstamp(i)−Tstamp(b))/8(ms)
Tpi: play time of the incoming data packet
Tbp: play time of the base packet
Tstamp (i): time stamp of t the incoming data packet
Tstamp (b): time stamp of the a base packet

If step 202 determines the base packet existed, the following step 203 calculates the delayed time of the incoming data packet. In one embodiment of the present invention, the delayed time of the incoming data packet (Ti) can be calculated as follows:

Ti=Ts−Tb+(Tstamp(i)−Tstamp(b))/8(ms)
Ti: the delayed time of the incoming data packet
Ts: system time
Tb: arriving time of the base packet
Tstamp (i): time stamp of the incoming data packet
Tstamp (b): time stamp of the base packet

Then step flows to step 204 to classify the delayed time of the incoming data packet into the predetermined time zone, and then proceed by choosing one the two scenarios (step 205, 208) as next step.

If the delayed time of the incoming data packet is within predetermined time zone 1, for example, greater than −3000 ms and smaller than −120 ms, step flows to step 205 to calculate delayed time of the base packet, more specifically, to shift the play time of the base packet forward. In one embodiment of the present invention, the play time of base packet can be adjusted as below:

Tbp(new)=Tbp(old)+Ti/2
Tbp (new): new play time of the base packet
Tbp (old): old play time of the base packet
Ti: delayed time of the incoming data packet

Next, step flows to step 207 and then to step 208 to set a play time to each data packet by the methods mentioned in the previous paragraph.

If the delayed time of the incoming data packet is within the span of predetermined time zone 2, for example, greater than −120 ms and smaller than 3000 ms, step flows directly from step 204 to step 208, in which the system sets a play time to this data packet.

After going through above steps, which part of a data packet stream should be dropped and the play time sequence of the remaining data packet stream in a jitter buffer is determined; then, in step 209, the incoming data packet mentioned above is inserted into the jitter buffer waiting for playing and sorting the data packets in the jitter buffer in sequence; then step flow to step 210, waiting for a new incoming data packet.

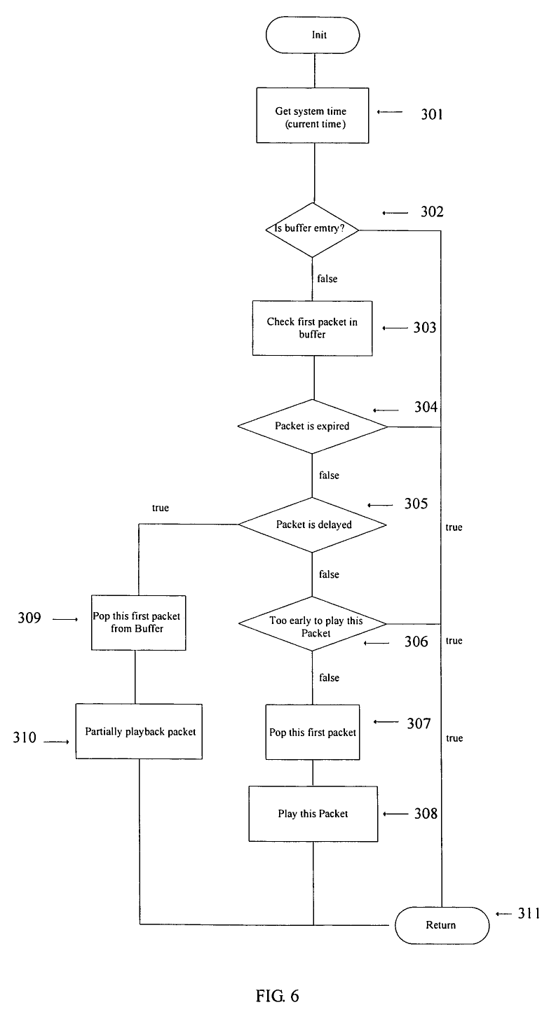

FIG. 5 and FIG. 6 illustrate schematic diagrams of one embodiment of sub data packet drop method. Referring to FIG. 6, n step 301, the system gets system time for calculating arriving time of an incoming data packet. After receiving an incoming data packet of a data packet stream from data packet networks, step 302 determines whether the buffer is empty; if the determination is negative, then the next step flows to step 303, if it is positive, step flows to step 311,waiting for a new incoming data packet. Next, if step 302 determines that there is a base packet existed in the buffer, step flows to step 303 to check the status of first data packet in the jitter buffer, and then flow to step 304. Step 304 determines whether the data packet is expired or not, in one embodiment of the present invention, expired means that a communication device has played the receiving voice a period of time that exceed the play time of an incoming data packet. Therefore, if the determination is positive, this data packet would be dropped and step flows to step 311; if the determination is negative, step flows to step 305; step 305 would determines whether the data packet is delayed or not; in one embodiment of the present invention, delayed means Tsys−(Tpp+120 (ms)) >0; wherein Tsys represents current system time and Tpp represents play time of the incoming data packet. If it is negative, step flows to step 306, if it is positive, step flows to step 309. Step 309 would pop the incoming data packet from buffer and then step flows to step 310 to determine if a segment of the data packet of which the incoming data packet is the first data packet, should be dropped; In one embodiment, if the PCM value of the data packet stream segment is between 2000 and −2000 and the duration of the data packet stream segment is longer than 20 ms, this segment would be regard as background noise or silence and then dropped. Then play the remaining part of the data packet stream.

Referring back to step 305, if step 305 determines that the data packet is not delayed, then step flows to step 306 to determine whether the data packet arrives too early to play this data packet or not; In one embodiment of the present invention, the data packet is regarded as too early if Tsys−Tpp <0. If it is positive, step flows to step 311 waiting for a new initiation of the method, if it is negative, step flows to step 307 to pop this data packet waiting for playing at expected time in step 308.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A communicating device for VoIP communication, comprising:
a call control unit;
a voice engine processor with a jitter buffer coupled to said call control unit for dynamically determining the delayed time of a base packet of a data packet stream or for selectively dropping a segment of a delayed data packet stream representing background noise or silence;
an board coupled to said voice engine processor for voice acquisition and output; and
a network interface coupled to said voice engine processor for receiving said data packet and transmitting said data packet to another communicating device.

2. The communicating device of claim 1, wherein said voice engine processor utilizes at least timestamp and arriving time of an incoming data packet and said base packet to dynamically determine the delayed time of said base packet of said data packet stream.

3. The communicating device of claim 1, wherein said voice engine processor comprises an encoder and a data packeting unit (DPU) to generate data packets.

4. The communicating device of claim 1, wherein said voice engine processor comprises a de-data packeting unit (de-DPU) and a decoder to reconstruct voice.

5. The communicating device of claim 1, wherein said network interface comprises a wifi chip.

6. A handling method of an incoming data packet for a communicating device for VoIP communication, comprising:
configuring at least one time zone;
classifying the delayed time of an incoming data packet into said time zone for calculating the play time of a base packet and for adjusting the play time of data packets in a jitter buffer accordingly; and
setting a play time to said incoming data packet.

7. The method for handling an incoming data packet of claim 6, wherein said time zones comprising time zone 1 and time zone 2.

8. The method for handling an incoming data packet of claim 6, wherein said delayed time is calculated at least by timestamp and arriving time of said incoming data packet and said base packet.

9. The method for handling an incoming data packet of claim 6, wherein if said delayed time of said incoming data packet is beyond the total span of said time zones, utilizing said incoming data packet as a base packet.

10. The method for handling an incoming data packet of claim 7, wherein if said delayed time of said incoming data packet is within said time zone 1, adjusting the delayed time of said base packet.

11. The method for handling an incoming data packet of claim 7, wherein if said delayed time of said incoming data packet is within said time zone 2, setting a play time to said incoming data packet.

12. The method for handling an incoming data packet of claim 9, wherein said total span of said time zones is greater than −3 seconds and smaller than 3 seconds.

13. The method for handling an incoming data packet of claim 10, wherein said time zone 1 is greater than −3000 ms and smaller than −120 ms.

14. The method for handling an incoming data packet of claim 11, wherein said time zone 2 is greater than −120 ms and smaller than 3000 ms.

15. A handling method of an incoming call for a communicating device for VoIP communication, comprising:
determining if an incoming data packet of a data packet stream is delayed;
if said determination is positive, utilizing predetermined parameters to determine which segment of said data packet stream representing background noise or silence; and then
dropping said segment.

16. The method for handling an incoming data packet of claim 15, wherein said delayed is calculated at least by play time of said incoming data packet and system time.

17. The method for handling an incoming data packet of claim 15, wherein said delayed means (Tsys−(Tpp+n))>0; wherein Tsys represents system time and Tpp represents play time of said data packet and n is greater than 0.

18. The method for handling an incoming data packet of claim 15, wherein n is 120 ms.

19. The method for handling an incoming data packet of claim 15, wherein said predetermined parameters comprises PCM value and duration time of said segment of data packet stream.

20. The method for handling an incoming data packet of claim 19, wherein said PCM value is between 2000 and −2000 and said duration time is longer than 20 ms.
